(19) United States
(12) Patent Application Publication
(10) Pub. No.: US 2026/0188958 A1
(43) Pub. Date: Jul. 2, 2026

(54) ROTARY SOCKET

(71) Applicant: TONGHUA INTELLIGENT TECHNOLOGY CO.,LTD, DONGGUAN (CN)

(72) Inventor: ZHIJIN LI, DONGGUAN (CN)

(21) Appl. No.: 19/013,167

(22) Filed: Jan. 8, 2025

(30) Foreign Application Priority Data
Jan. 2, 2025 (CN) 202520011996.X

(51) Int. Cl. H01R 25/00; H01R 13/24; H01R 13/512; H01R 27/02; H01R 35/04

(52) U.S. Cl. CPC H01R 25/006; H01R 13/24; H01R 13/512; H01R 27/02; H01R 35/04

(57) ABSTRACT

A rotary socket is provided, including an outer housing, a control board, at least one receptacle module, a rotary fixing module, and a plug. The outer housing includes a cover plate and a receptacle housing body, the cover plate is disposed at one side of the receptacle housing body, both the control board and the at least one receptacle module are disposed in the receptacle housing body, the receptacle housing body defines at least one receiving hole corresponding to the at least one receptacle module, both the plug and the at least one receptacle module are electrically connected to the control board. The cover plate defines a rotary fixing groove, the rotary fixing module includes a rotary component and a rotary fixing component, the rotary fixing component defines a rotary groove, a rotary positioning step is disposed at a periphery of the rotary fixing groove.

### TECHNICAL FIELD

The present disclosure relates to the field of electrical appliances, and in particular to a rotary socket.

### BACKGROUND

Sockets, also referred to as power sockets or power strips, are widely used electrical distribution devices, a basic principle of which is to extend a single power socket into multiple outlets, thereby allowing multiple electrical appliances to be connected to a single power source. The sockets each typically consists of a plastic housing, an internal copper conductive component, and a safety protection device. Each plastic housing not only serves as an insulator but also effectively prevents an electrical shock risk, moreover, each plastic housing also prevents internal structures of a corresponding socket from external environment interference. Each internal copper conductive component is configured to transmit currents, conductivity of which directly affects security and usage efficiency of a corresponding socket.

Current sockets are all provided with fixed structures that cannot be adjusted in terms of angle, so that practical environmental use is limited. Therefore, a new socket design is required to address such limitations.

### SUMMARY

I order to solve above problems, the present disclosure provides a rotary socket, in which a rotary fixing module is provided to enable a plug portion to freely rotate. Users may easily adjust an orientation of a plug according to actual needs, thereby avoiding inconvenience caused by that conventional sockets only have a fixed orientation. The rotary socket of the present disclosure is especially advantageous in environments with limited space or tightly configured living spaces, significantly enhancing flexibility and convenience of use.

Technical solutions adopted by the present disclosure are as following.

The rotary socket includes an outer housing, a control board, at least one receptacle module, a rotary fixing module, and a plug. The outer housing includes a cover plate and a receptacle housing body, the cover plate is disposed at one side of the receptacle housing body, both the control board and the at least one receptacle module are disposed in the receptacle housing body, the receptacle housing body defines at least one receiving hole corresponding to the at least one receptacle module, both the plug and the at least one receptacle module are electrically connected to the control board. The cover plate defines a rotary fixing groove, the rotary fixing module includes a rotary component and a rotary fixing component, the rotary fixing component defines a rotary groove, a rotary positioning step is disposed at a periphery of the rotary fixing groove, the rotary positioning step is opposite to the rotary groove, a rotary ring is disposed at a periphery of the rotary component, the rotary ring is rotatably disposed in the rotary groove, the rotary ring includes a limiting step, one surface of the limiting step abuts against the rotary positioning step, and the plug is disposed on the rotary component.

Beneficial effects of the present disclosure are as following.

Compared with the conventional sockets, the present disclosure provides the rotary socket, in which the rotary fixing module is provided to enable the plug portion to freely rotate. The users may easily adjust the orientation of the plug according to actual needs, thereby avoiding the inconvenience caused by that the conventional sockets only have a fixed orientation. The rotary socket of the present disclosure is especially advantageous in the environments with the limited space or the tightly configured living spaces, significantly enhancing the flexibility and the convenience of the use. Precision fit between the rotary fixing groove and the rotary groove and precision fit between the rotary positioning step and the limiting step ensure smooth and stable rotation, thereby preventing potential safety hazards caused by improper rotation. Components in the rotary fixing module, such as the rotary ring with the limiting step, are made of wear-resistant and corrosion-resistant materials, which ensures smooth operation and long-term durability even under prolonged and repeated rotational use. Additionally, relative arrangement of the rotary positioning step and the rotary groove not only achieves precise angular positioning but also allows the users to quickly return the rotary socket to an original assembly position when needed, which simplifies maintenance procedures.

Electrical connection between the control board, the at least one receptacle module, and the plug of the rotary socket adopts a high-reliability design to ensure stability and security of current transmission. The at least one receiving hole defined on the receptacle housing body not only meets international safety standards, but is also meticulously designed in terms of layout and dimensions to effectively prevent incorrect insertion and reduce a risk of electric shock. Moreover, a structural design of the rotary component and the rotary fixing component in the rotary fixing module is meticulously engineered to meet electrical isolation and insulation requirements, thereby further enhancing overall security performance. By rotating the plug, the users may easily connect power cords or charging cables of different directions and sizes, in this way, a problem that the power cords or charging cables are disordered due to the fixed orientation of the conventional sockets is avoided. Such design not only improves spatial tidiness but also enhances user comfort and convenience. The present disclosure provides a unique design concept and an excellent technical effect, which enables a more flexible, safer, and more convenient user experience, thereby addressing diverse functional requirements of modern living and further enhancing overall user satisfaction of the rotary socket.

### BRIEF DESCRIPTION OF DRAWINGS

FIG. 1 is a three-dimensional schematic diagram of a rotary socket of the present disclosure.

FIG. 2 is an exploded schematic diagram of the rotary socket shown in FIG. 1.

FIG. 3 is another exploded schematic diagram of the rotary socket shown in FIG. 1.

FIG. 4 is a front view schematic diagram of the rotary socket shown in FIG. 1.

FIG. 5 is a cross-sectional schematic diagram taken along line A-A shown in FIG. 4.

FIG. 6 is an exploded schematic diagram of a partial structure of the rotary socket shown in FIG. 1.

FIG. 7 is a structural schematic diagram of a plug shown in FIG. 1 according to one embodiment of the present disclosure.

Reference numerals in the drawings: 1. outer housing; 11. cover plate; 111. rotary fixing groove; 112. rotary positioning step; 1121. angle positioning block; 113. first connecting column; 114. second connecting column; 115. third connecting column; 1151. supporting platform; 12. receptacle housing body; 121. assembly positioning groove; 122. matching connecting column; 2. control board; 21. universal serial bus (USB) connector; 3. receptacle module; 31. receptacle positioning strip; 32. conductive fixing case; 321. fixing bracket; 322. separation layer; 33. conductive elastic piece; 4. rotary fixing module; 41. rotary component; 411. rotary ring; 412. limiting step; 413. rotary positioning piece; 414. fixing clamping groove; 42. rotary fixing component; 421. rotary groove; 422. fixing connecting column; 5. plug; 51. first prong; 511. first contact elastic piece; 512. first contact protrusion; 52. second prong; 521. second contact elastic piece; 522. second contact protrusion; 53. fixing component; 6. conductive component; 61. inner conductive ring; 611. first annular groove; 62. outer conductive ring; 621. second annular groove.

### DETAILED DESCRIPTION OF EMBODIMENTS

In order to facilitate understanding of the present disclosure, the present disclosure is described more fully hereinafter with reference to accompanying drawings. Preferred embodiments of the present disclosure are shown in the accompanying drawings. However, the present disclosure is enabled to implement in many different forms and is not limited to the embodiments described herein. On the contrary, a purpose of providing these embodiments is to make the understanding of the present disclosure more thorough and comprehensive.

It should be noted that when a component is referred to as being “fixed to” another component, it may be directly on another component or intermediate components may also be present. When a component is considered to be “connected to” another component, it may be directly connected to another component or intermediate components may be present at the same time.

Unless otherwise defined, all technical and scientific terms used herein have the same meaning as commonly understood by those who skilled in a technical field of the present disclosure. Terms used in the specification of the present disclosure are merely for a purpose of describing specific embodiments, and are not intended to limit the present disclosure.

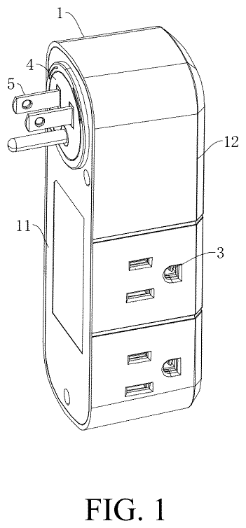

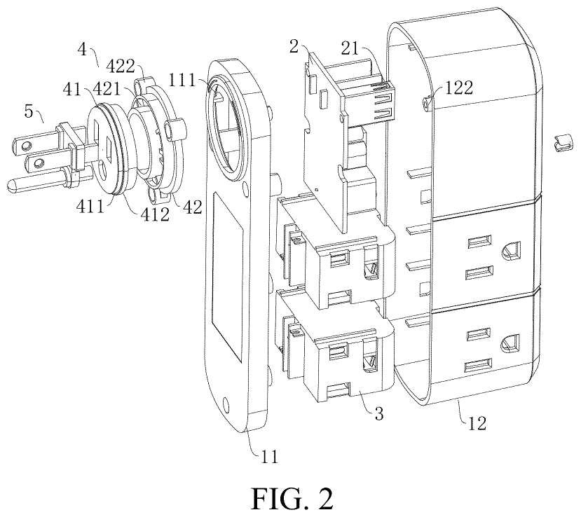

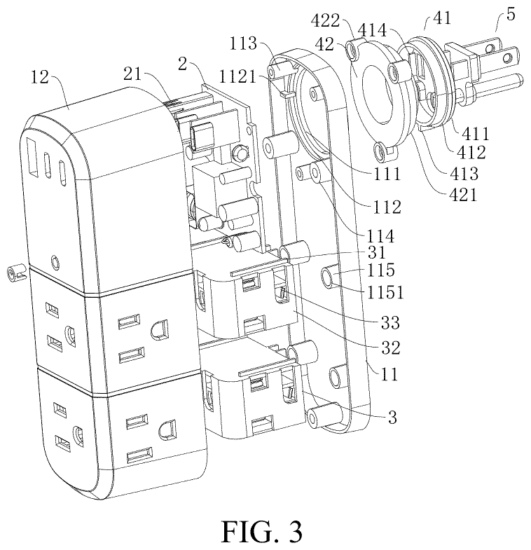

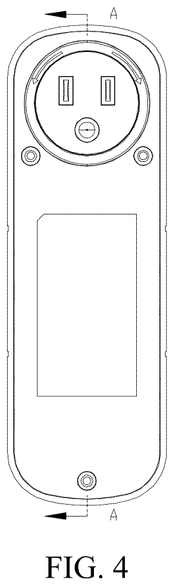

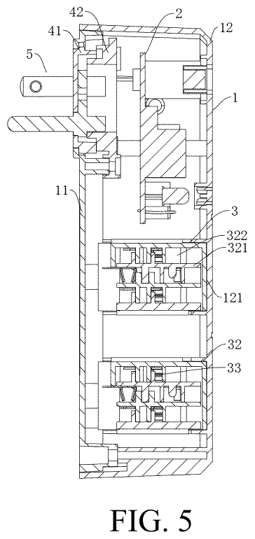

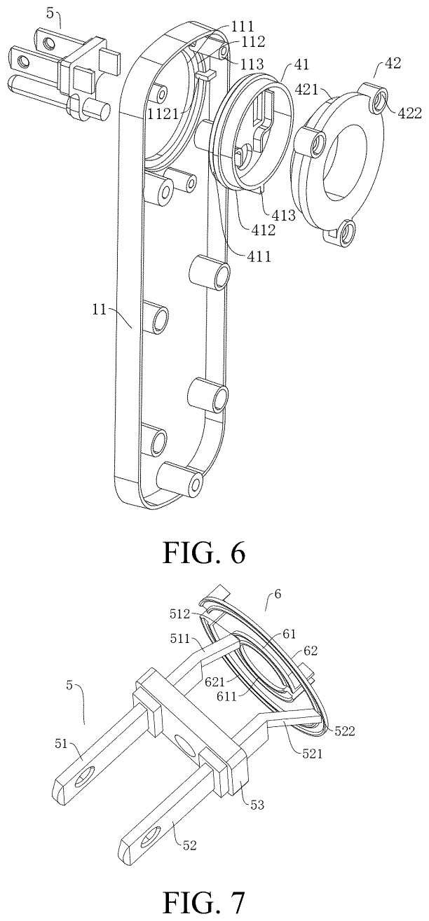

As shown in FIGS. 1-7, the embodiments of the present disclosure provides a rotary socket, including an outer housing 1, a control board 2, at least one receptacle module 3, a rotary fixing module 4, and a plug 5. The outer housing 1 includes a cover plate 11 and a receptacle housing body 12, the cover plate 11 is disposed at one side of the receptacle housing body 12, both the control board 2 and the at least one receptacle module 3 are disposed in the receptacle housing body 12, the receptacle housing body 12 defines at least one receiving hole corresponding to the at least one receptacle module 3, both the plug 5 and the at least one receptacle module 3 are electrically connected to the control board 2. The cover plate 11 defines a rotary fixing groove 111, the rotary fixing module 4 includes a rotary component 41 and a rotary fixing component 42, the rotary fixing component 42 defines a rotary groove 421, a rotary positioning step 112 is disposed at a periphery of the rotary fixing groove 111, the rotary positioning step 112 is opposite to the rotary groove 421, a rotary ring 411 is disposed at a periphery of the rotary component 41, the rotary ring 411 is rotatably disposed in the rotary groove 421, the rotary ring 411 includes a limiting step 412, one surface of the limiting step 412 abuts against the rotary positioning step 112, and the plug 5 is disposed on the rotary component 41. According to the embodiments of the present disclosure, the rotary fixing module 4 is provided to enable a plug portion to freely rotate. Users may easily adjust an orientation of the plug 5 according to actual needs, thereby avoiding inconvenience caused by that conventional sockets only have a fixed orientation. The rotary socket of the present disclosure is especially advantageous in environments with limited space or tightly configured living spaces, significantly enhancing flexibility and convenience of use. Precision fit between the rotary fixing groove 111 and the rotary groove 421 and precision fit between the rotary positioning step 112 and the limiting step 412 ensure smooth and stable rotation, thereby preventing potential safety hazards caused by improper rotation. Components in the rotary fixing module 4, such as the rotary ring 411 with the limiting step 412, are made of wear-resistant and corrosion-resistant materials, which ensures smooth operation and long-term durability even under prolonged and repeated rotational use. Additionally, relative arrangement of the rotary positioning step 112 and the rotary groove 421 not only achieves precise angular positioning but also allows the users to quickly return the rotary socket to an original assembly position when needed, which simplifies maintenance procedures.

In the embodiments, electrical connection between the control board 2, the at least one receptacle module 3, and the plug 5 of the rotary socket adopts a high-reliability design to ensure stability and security of current transmission. The at least one receiving hole defined on the receptacle housing body 12 not only meets international safety standards, but is also meticulously designed in terms of layout and dimensions to effectively prevent incorrect insertion and reduce a risk of electric shock. Moreover, a structural design of the rotary component 41 and the rotary fixing component 42 in the rotary fixing module 4 is meticulously engineered to meet electrical isolation and insulation requirements, thereby further enhancing overall security performance. By rotating the plug 5, the users may easily connect power cords or charging cables of different directions and sizes, in this way, a problem that the power cords or charging cables are disordered due to the fixed orientation of the conventional sockets is avoided. Such design not only improves spatial tidiness but also enhances user comfort and convenience. The present disclosure provides a unique design concept and an excellent technical effect, which enables a more flexible, safer, and more convenient user experiences, thereby addressing diverse functional requirements of modern living and further enhancing overall user satisfaction of the rotary socket.

The cover plate 11 includes first connecting columns 113, at least one second connecting column 114, and at least one third connecting column 115. c. The rotary fixing component 42 includes fixing connecting columns 422, the fixing connecting columns 422 are connected to the first connecting columns 113 through first screws. The receptacle housing body 12 includes at least one matching connecting column 122, the at least one second connecting column 114 is connected to the at least one matching connecting column 122 through at least one second screw. The at least one third connecting column 115 includes a supporting platform 1151, the supporting platform 1151 is configured to support the at least one receptacle module 3. In the embodiment, the first connecting columns 113 are uniformly disposed at the periphery of the rotary fixing groove 111 in the circumferential direction, such layout does not only enhance connection strength between the cover plate 11 and the rotary fixing component 42, but also ensures stability and durability of rotation between the cover plate 11 and the rotary fixing component 42. The first connecting columns 113 and the fixing connecting columns 422 are fastened through first screws to form a reliable fixation, which effectively prevents the cover plate 11 and the rotary fixing component 42 from loosening or displacement due to the rotation. Moreover, the at least one matching connecting column 122 is connected to the at least one second connecting column 114 through the at least one second screw to further enhance overall structural stability of the rotary socket. In this way, the receptacle housing body 12 is securely fixed to the cover plate 11, maintaining a reliable connection even under frequent insertion and removal of the plug 5. Furthermore, the supporting platform 1151 of the at least one third connecting column 115 offers a stable base for the at least receptacle module 3. Such design not only optimizes an internal space layout of the rotary socket but also significantly enhances convenience and stability of installation of the at least one receptacle module 3. Through securely fixing the at least one receptacle module 3 to a designated position by the supporting platform 1151, optimal electrical and security performance of the rotary socket is ensured.

An angle positioning block 1121 is disposed on the rotary positioning step 112, a rotary positioning piece 413 is disposed on the rotary component 41, the angle positioning block 1121 is configured to abut against the rotary positioning piece 413, so as to limit a rotating angle of the rotary component 41. In the embodiment, the angle positioning block 1121 on the rotary positioning step 112 ensures precise control during rotation of the rotary component 41. The angle positioning block 1121 serves as a key component, shape and dimensions of the angle positioning block 1121 are meticulously calculated to achieve a close and reliable engagement with the rotary positioning piece 413 on the rotary component 41. Such engagement mechanism not only enhances stability of the rotary component 41 at specific angular positions but also effectively prevents unintended rotation due to external forces, thereby ensuring security of the rotary socket during use. Moreover, such structure significantly improves operational convenience of the rotary socket. The users may easily rotate the rotary component 41 to a desired angle as needed and achieve quick and accurate positioning through interaction between the angle positioning block 1121 and the rotary positioning piece 413, which enables a smoother insertion and removal operation, thereby significantly enhancing user experience.

The receptacle housing body 12 defines at least one assembly positioning groove 121, the at least one receptacle module 3 includes at least one receptacle positioning strip 31, the at least one receptacle positioning strip 31 is configured to match with the at least one assembly positioning groove 121 for assembling and positioning the at least one receptacle module 3. In the embodiment, the at least one receptacle module 3 includes the at least one receptacle positioning strip 31 with shape and dimensions precisely matched to the at least one assembly positioning groove 121, which not only simplifies an assembly process but also significantly improves assembly efficiency. In practical operation, the users may easily install the at least one receptacle module 3 by simply aligning the at least one receptacle positioning strip 31 31 with the at least one assembly positioning groove 121 without complex adjustments or calibration steps. More importantly, such assembly method greatly enhances structural stability and security of the rotary socket. Close fit between the at least one assembly positioning groove 121 and the at least one receptacle positioning strip 31 31 effectively prevents the at least one receptacle module 3 from loosening or falling off during use, thereby ensuring a normal operation of the rotary socket and safeguarding user safety.

The rotary socket further includes a conductive component 6, the conductive component 6 is disposed on the control board 2 and includes an inner conductive ring 61 and an outer conductive ring 62. The plug 5 includes a first prong 51 and a second prong 52, the first prong 51 includes a first contact elastic piece 511, the second prong 52 includes a second contact elastic piece 521, the first contact elastic piece 511 is configured to be in contact with the inner conductive ring 61, and the second contact elastic piece 521 is configured to be in contact with the outer conductive ring 62. Specifically, the inner conductive ring 61 defines a first annular groove 611, the outer conductive ring 62 defines a second annular groove 621. The first contact elastic piece 511 includes a first contact protrusion 512, the second contact elastic piece 521 includes a second contact protrusion 522. The first contact protrusion 512 is configured to match with the first annular groove 611, and the second contact protrusion 522 is configured to match with the second annular groove 621. In the embodiment, the conductive component 6 is provided to achieve precise alignment between the plug 5 and the control board 2. Specifically, the inner conductive ring 61 and the outer conductive ring 62 are provided to not only optimize a current transmission path but also enhance electrical load capacity of the rotary socket, so that the rotary socket safely and stably transmits higher-power currents. Moreover, the first prong 51 and second prong 52 of the plug 5 are respectively provided with the first contact elastic piece 511 and second contact elastic piece 521. The first contact elastic piece 511 and second contact elastic piece 521 possess excellent elasticity and conductivity, so as to ensure a close and reliable contact between the plug 5 and the inner conductive ring 61 and outer conductive ring 62 when the plug 5 is inserted into the outer housing 1 of the rotary socket. Such design effectively reduces electrical failures caused by poor contact, thereby enhancing security of the rotary socket during use. Furthermore, the inner conductive ring 61 and the outer conductive ring 62 respectively define the first annular groove 611 and the second annular groove 621, the first contact elastic piece 511 and the second contact elastic piece 521 respectively include the first contact protrusion 512 and the second contact protrusion 522, which further strengthens stability of electrical connection of the rotary socket. Such interlocking design, featuring grooves and protrusions, not only enhances connection tightness between the plug 5 and the outer housing 1 of the rotary socket but also effectively prevents loosening of the plug 5 during rotation. Consequently, stability and durability of the rotary socket across a wide range of usage scenarios are further ensured.

The rotary component 41 defines a fixing clamping groove 414 at one side thereof, the plug 5 includes at least one fixing component 53, the at least one fixing component 53 is configured to fix the plug 5 in the fixing clamping groove 414. In the embodiment, close fit between the fixing clamping groove 414 and the at least one fixing component 53 effectively prevents the plug 5 from accidentally falling off due to external forces during use, thereby enhancing the security and the reliability of the rotary socket. Moreover, such structure facilitates the users to perform insertion and removal operation on the plug 5. The users may easily secure the plug 5 within the fixing clamping groove 414 or remove the plug 5 by simply performing a rotational motion, which greatly simplifies an operation process and further improves usage efficiency.

At least one universal serial bus (USB) connector 21 is disposed on the control board 2, the receptacle housing body 12 defines at least one USB port 123, the at least one USB port 123 is configured to match with the at least one USB connector 21. According to the embodiment, the users no longer need to carry or use an additional USB charger, as the users may directly charge electronic devices through the at least one USB port 123 on the rotary socket, fulfilling a modern demand for convenient charging of the electronic devices. Moreover, such design optimizes a spatial layout of the rotary socket, which reduces a space occupied by a conventional rotary socket, so that the rotary socket is more compact and efficient. Meanwhile, cooperation between the at least one USB port 123 and the at least one USB connector ensures stable and safe current transmission, which avoids device damage or safety hazards that may result from improper charging.

The at least one receptacle module 3 includes a conductive fixing case 32 and at least two conductive elastic pieces 33, the conductive fixing case 32 is disposed in the receptacle housing body 12, and the at least two conductive elastic pieces 33 are disposed in the conductive fixing case 32. Specifically, a fixing bracket 321 is disposed in the conductive fixing case 32, at least one separation layer 322 is disposed in the fixing bracket 321, and the at least two conductive elastic pieces 33 are disposed on the at least one separation layer 322. In the embodiment, the conductive fixing case 32 is disposed in the receptacle housing body 12 of the rotary socket, which not only ensures secure installation of conductive components but also effectively prevents loosening or displacement caused by the rotation of the rotary socket, thereby ensuring security and stability of the electrical connection of the rotary socket. Meanwhile, the at least two conductive elastic pieces 33 are disposed on the at least one separation layer 322 in the conductive fixing case 32. Such layout not only optimizes an electrical contact area, enhances current transmission efficiency, but also allows for self-adjusting and close fit of mating components of the rotary socket using elastic properties of elastic pieces. Furthermore, the fixing bracket 321 and the at least one separation layer 322 in the outer housing 1 provide a stable support structure for the at least two conductive elastic pieces 33. By means of reasonable spatial separation, interference and short-circuit risks between different circuits are avoided, thereby further improving the security performance of the rotary socket.

The above embodiments only express several implementations of the present disclosure, and the description thereof is relatively specific and detailed, but cannot be understood as a limitation to a protection scope of the present disclosure. It should be noted that, for those who skilled in the art, several modifications and improvements may be made without departing from a concept of the present disclosure, which all fall within the protection scope of the present disclosure. Therefore, the protection scope of the present disclosure shall be subject to appended claims.

What is claimed is:

1. A rotary socket, comprising:
an outer housing;
a control board;
at least one receptacle module;
a rotary fixing module; and
a plug;
wherein the outer housing comprises a cover plate and a receptacle housing body, the cover plate is disposed at one side of the receptacle housing body, both the control board and the at least one receptacle module are disposed in the receptacle housing body, the receptacle housing body defines at least one receiving hole corresponding to the at least one receptacle module, both the plug and the at least one receptacle module are electrically connected to the control board;
wherein the cover plate defines a rotary fixing groove, the rotary fixing module comprises a rotary component and a rotary fixing component, the rotary fixing component defines a rotary groove, a rotary positioning step is disposed at a periphery of the rotary fixing groove, the rotary positioning step is opposite to the rotary groove, a rotary ring is disposed at a periphery of the rotary component, the rotary ring is rotatably disposed in the rotary groove, the rotary ring comprises a limiting step, one surface of the limiting step abuts against the rotary positioning step, and the plug is disposed on the rotary component.

2. The rotary socket according to claim 1, wherein the cover plate comprises first connecting columns, at least one second connecting column, and at least one third connecting column;
the first connecting columns are uniformly disposed at the periphery of the rotary fixing groove in a circumferential direction;
the rotary fixing component comprises fixing connecting columns, the fixing connecting columns are screwed to the first connecting columns;
the receptacle housing body comprises at least one matching connecting column, the at least one second connecting column is screwed to the at least one matching connecting column; and
the at least one third connecting column comprises a supporting platform, the supporting platform is configured to support the at least one receptacle module.

3. The rotary socket according to claim 1, wherein an angle positioning block is disposed on the rotary positioning step, a rotary positioning piece is disposed on the rotary component, the angle positioning block is configured to abut against the rotary positioning piece, so as to limit a rotating angle of the rotary component.

4. The rotary socket according to claim 1, wherein the receptacle housing body defines at least one assembly positioning groove, the at least one receptacle module comprises at least one receptacle positioning strip, the at least one receptacle positioning strip is configured to match with the at least one assembly positioning groove for assembling and positioning the at least one receptacle module.

5. The rotary socket according to claim 1, wherein the rotary socket further comprises a conductive component, the conductive component is disposed on the control board and comprises an inner conductive ring and an outer conductive ring; and
the plug comprises a first prong and a second prong, the first prong comprises a first contact elastic piece, the second prong comprises a second contact elastic piece, the first contact elastic piece is configured to be in contact with the inner conductive ring, and the second contact elastic piece is configured to be in contact with the outer conductive ring.

6. The rotary socket according to claim 5, wherein the inner conductive ring defines first annular groove, the outer conductive ring defines a second annular groove;
the first contact elastic piece comprises a first contact protrusion, the second contact elastic piece comprises a second contact protrusion; and
the first contact protrusion is configured to match with the first annular groove, and the second contact protrusion is configured to match with the second annular groove.

7. The rotary socket according to claim 1, wherein the rotary component defines a fixing clamping groove at one side thereof, the plug comprises at least one fixing component, the at least one fixing component is configured to fix the plug in the fixing clamping groove.

8. The rotary socket according to claim 1, wherein at least one universal serial bus (USB) connector is disposed on the control board, the receptacle housing body defines at least one USB port, the at least one USB port is configured to match with the at least one USB connector.

9. The rotary socket according to claim 1, wherein the at least one receptacle module comprises a conductive fixing case and at least two conductive elastic pieces, the conductive fixing case is disposed in the receptacle housing body, and the at least two conductive elastic pieces are disposed in the conductive fixing case.

10. The rotary socket according to claim 9, wherein a fixing bracket is disposed in the conductive fixing case, at least one separation layer is disposed in the fixing bracket, and the at least two conductive elastic pieces are disposed on the at least one separation layer.
